(19) United States
(12) Patent Application Publication
(10) Pub. No.: US 2004/0114375 A1
(43) Pub. Date: Jun. 17, 2004

(54) Sign frame

(76) Inventor: Jeffrey G. Nimmer, Mukwonago, WI (US)

Correspondence Address: Casimir F. Laska, Michael Best & Friedrich LLP, 100 East Wisconsin Avenue, Milwaukee, WI, 53202-4108, US

(21) Appl. No.: 10/317,466

(22) Filed: Dec. 12, 2002

(51) Int. Cl. F21V 21/00

(52) U.S. Cl. 362/396; 362/216; 362/812

(57) ABSTRACT

A frame and a method of making a frame for supporting a sign having a gas discharge tube. The frame includes a plurality of frame members. Each of the frame members is made entirely of extruded plastic. A plurality of tube hangers are coupled to the frame members for supporting the tube. At least some of the frame members are made of extruded polycarbonate, extruded polyvinyl chloride, or other suitable plastics. The method includes extruding a length of plastic and forming the sign from the length of extruded plastic. The forming step can include cutting the length of plastic into a plurality of plastic members and securing the plurality of plastic members together to form the frame.

### FIELD OF THE INVENTION

The invention relates to frames for signs and other display devices, and more specifically to frames for gas discharge-type signs.

### BACKGROUND OF THE INVENTION

Prior art gas discharge-type sign frames are typically made from pieces of metal bar stock that are cut, bent, and then fastened together using conventional welding techniques, rivets, screws, adhesives, or other similar fasteners to achieve the desired configuration. The metal frames are also usually painted black.

Typically, a number of vertical and horizontal support members are arranged and fastened together in a configuration suitable for supporting the specific gas tube. A plurality of tube hangers are positioned on the support members to support the gas tube on the front side of the frame. The tube hangers are typically riveted or screwed onto the support members and include clips for supporting the tube.

Some of the support members are bent forwardly to form window bumpers that create separation between the gas tube and the window or surface against which the sign hangs. The window bumpers typically include a soft, rubber-like end cover that provides a soft surface for engagement with a window or other surface against which the frame rests.

### SUMMARY OF THE INVENTION

The invention provides an improved sign frame that is made entirely or almost entirely of plastic instead of metal. The improved frame is less costly to manufacture than the prior art metal frame. No special metal-working tools or machines are needed to manufacture the inventive frame. Additionally, unlike prior art metal frames, there is no need to electrically ground or paint the plastic frame. In addition, the inventive frame is lighter and allows the overall size of the sign to be smaller than if a prior art metallic frame were used. The lighter-weight and smaller sign reduces the cost of packaging and shipping.

The frame of the invention is made of extruded plastic pieces (e.g., polycarbonate, polyvinyl chloride, and the like) that can be easily cut to the desired size and assembled using mechanical fasteners, such as staples, screws, and the like, conventional adhesives, heat welding techniques, friction welding techniques, or solvent bonding techniques. Window bumpers are coupled to the main support members using plastic “L” or “T”-shaped inserts sized to fit within the extruded plastic pieces. The inserts can be made of molded or cut plastics (e.g., polycarbonate), and provide support for the window bumpers. Because the window bumpers are also made of the same extruded plastic, which is softer than metal and which can be easily cut to have smooth ends, no end covers are required on the ends of the window bumpers.

The construction of the inventive frame also provides for smaller and less cumbersome to mount hanging brackets. Support feet can also be easily added to or removed from the inventive frame in the same manner discussed above with respect to the window bumpers.

The frame also provides for the power supply to be mounted on the front of the sign. This, in combination with the smaller mounting brackets, makes a sign constructed with the inventive frame thinner from front to back, and therefore, smaller, lighter, and less cumbersome.

The tube hangers can be easily mounted to the plastic frame pieces using screws, rivets, or other conventional fasteners, which can be more easily inserted into the plastic members than into the prior art metal frames. Additionally, the shape of the extruded plastic members provides added options for mounting tube hangers. For example, the tube hangers can be mounted to the plastic members using clips that are configured to snap onto the plastic members. The clips can be slidable on the outer surface of the plastic members to facilitate positioning the tube hangers for receiving the gas tube.

Various cross-sectional shapes can be chosen for the plastic frame pieces to facilitate mounting of the tube hangers and the hanger brackets, and to achieve the desired strength and rigidity of the frame. Metal or plastic stiffening rods can be inserted into the tubular frame pieces, if desired, to further improve the rigidity of the frame and/or to facilitate the formation of butt joints. The cross-sectional configurations of the frame pieces can also facilitate routing and protecting the electrical wires.

More specifically, the invention provides a frame for supporting a sign having a gas discharge tube. The frame includes a plurality of frame members. Each of the frame members is made entirely of extruded plastic. A plurality of tube hangers are coupled to the frame members for supporting the tube. In one aspect of the invention, at least some of the frame members are made of at least one of extruded polycarbonate and extruded polyvinyl chloride. In another aspect of the invention, at least some of the frame members are fastened together by at least one of staples, screws, adhesives, heat welding, friction welding, and solvent bonding. The frame can further include an insert that engages both a first and a second frame member. The insert can be plastic, and can be substantially L-shaped or substantially T-shaped.

The invention also provides a method of manufacturing a frame for a sign having a gas discharge tube. The method includes extruding a length of plastic and forming the sign from the length of extruded plastic. In one aspect of the invention, the forming step includes cutting the length of plastic into a plurality of plastic members and securing the plurality of plastic members together to form the frame. In another aspect of the invention, the securing step includes securing at least some of the plastic members together by at least one of staples, screws, adhesives, heat welding, friction welding, and solvent bonding. In yet another aspect of the invention, the securing step includes securing at least some of the plastic members together using an insert received at least partially in an interior cavity defined in each of the plastic members being secured together.

The invention further provides a frame for supporting a sign having a gas discharge tube. The frame includes a first member made of extruded plastic and having an open end, a second member made of extruded plastic and having an open end, and an insert having a first leg received in the end of the first member and a second leg received in the end of the second member such that the first and second members are oriented substantially normal to one another.

Other features and advantages of the invention will become apparent to those skilled in the art upon review of the following detailed description and drawings.

### BRIEF DESCRIPTION OF THE DRAWINGS

FIG. 1 is a perspective view of a sign having a plastic frame embodying the invention.

FIG. 1A is a partial cross-section taken through the frame of FIG. 1 illustrating various mechanical fasteners for connecting pieces of the frame together.

FIG. 2 is a section view taken along line 2-2 of FIG. 1.

FIG. 2A is a section view similar to FIG. 2, illustrating the use of mechanical fasteners to connect the pieces of the frame together.

FIG. 3 is a section view illustrating an alternative corner insert that can be used in the construction of the frame illustrated in FIG. 1.

FIG. 4 is a section view taken along line 4-4 of FIG. 1.

FIG. 5 illustrates another hanger bracket arrangement.

FIG. 6 illustrates yet another hanger bracket arrangement.

FIG. 7 illustrates a portion of the frame having a reinforcing rod positioned therein.

FIG. 8 illustrates a portion of the frame acting as a conduit for electrical wiring.

FIG. 9 illustrates a portion of the frame having an alternative cross-sectional configuration and having a snap-on clip for mounting a tube hanger.

FIGS. 10-22 illustrate alternative cross-sectional configurations for the frame pieces.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

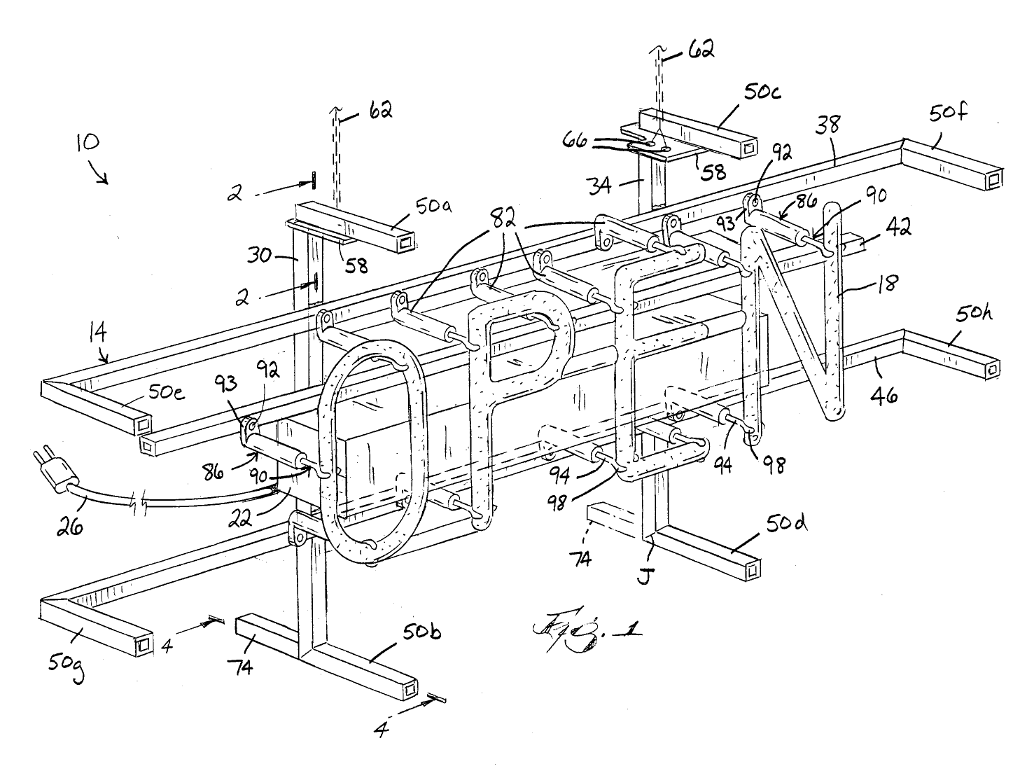

FIG. 1 illustrates a sign 10 including a frame 14 embodying the invention. The sign 10 includes a gas discharge tube 18 containing a gas, such as neon, argon, xenon, and the like, that can be illuminated into a variety of desired colors. Signs of this type are commonly referred to generically as “neon” signs. A power supply 22 provides electricity to ionize the gas in the tube 18, thereby causing the tube 18 to illuminate, as is understood by those skilled in the art. In the illustrated embodiment, the power supply 22 is secured to the front side of the frame 14, however, the power supply 22 can be secured to the back side of the frame 14, or alternatively, can be positioned in a location remote from the frame 14. A power cord 26 provides electrical power to the power supply 22.

The illustrated frame 14 is made almost entirely of plastic and includes two generally vertically-extending members 30, 34, and three generally horizontally-extending members 38, 42, 46. Each of the members 30, 34, 38, 42, and 46 is made of extruded plastic, such as polycarbonate, polyvinyl chloride, or other suitable plastics, and has a tubular cross-section. In the embodiment illustrated in FIG. 1, the tubular cross section is rectangular, and more precisely substantially square in shape. The interior cavity defined in the extruded members 30, 34, 38, 42, and 46 is also substantially square in cross-section. However, as will be described in more detail below, other cross-sectional configurations are also contemplated. Of course, the frame 14 could include additional members (not shown) that are not made of extruded plastic.

The horizontally-extending members 38, 42, and 46 are connected to the vertically-extending members 30, 34 by at least one of conventional mechanical fasteners, such as staples 55a, screws 55b, and the like (see FIG. 1A), adhesives 56 (see FIG. 1), heat welding, friction welding, and solvent bonding. Any suitable conventional mechanical fasteners, conventional adhesive, conventional heat welding technique, conventional friction welding technique, or conventional solvent bonding technique can be used. Depending on the specific gas tube 18 to be supported, the frame 14 can include more or fewer support members than that illustrated in FIG. 1. Additionally, the lengths, the respective orientations (vertical, horizontal, or otherwise), and the respective positional relationships of the illustrated support members 30, 34, 38, 42, and 46 can vary from frame to frame. The ease with which the configuration of the frame 14 can be changed from frame to frame is just one of the many appealing aspects of making the inventive frame 14 from support members of extruded plastic.

The support members 30, 34, 38, 42, and 46 can be extruded from any suitable plastic extruding machine. A length of plastic is extruded and the support members 30, 34, 38, 42, and 46 and other pieces of the frame 14 yet to be described are cut from the extrusion to the desired length. Preferably, black plastic is used to make the support members 30, 34, 38, 42, and 46 so that no painting is required. Alternatively, other colors of plastic or even clear plastic can be used if desired.

The frame 14 further includes window bumpers 50a-50h that extend forwardly from opposite ends of each of the vertical support members 30, 34, and the upper-most and lower-most horizontal support members 38 and 46, respectively. The window bumpers 50a-50h are also made from segments of extruded plastic preferably cut from the same extrusion from which the support members 30, 34, 38, 42, and 46 are cut. Because the window bumpers 50a-50h are made from plastic, and can be easily cut to have flat, smooth ends, there is no need for the soft end covers typically used on the window bumpers of prior art metal frames. Each window bumper 50a-50h is connected to its respective support member 30, 34, 38, 42, and 46 in a similar, if not identical manner.

Specifically, FIG. 2 illustrates the connection between the upper end of the vertical member 30 and the window bumper 50a. An L-shaped insert 54 includes first and second legs 54a and 54b, respectively. The first leg 54a is inserted into the open upper end of support member 30, while the second leg 54b is inserted into an open end of the window bumper 50a. The insert 54 thereby provides structural support for orienting the window bumper 50a substantially normal to the support member 30. The legs 54a, 54b of the insert 54 are sized and configured to fit snugly within the cavities defined in the ends of the member 30 and the window bumper 50a. A mechanical fastener, such as a staple 55a or a screw 55b (see FIG. 2a), or an adhesive 56 can be used to further secure the interconnection between the member 30, the insert 54, and the bumper 50a. The adhesive 56 can be applied to the legs 54a, 54b of the insert 54, to the support member 30 and the bumper 50a, or to any combination of the above.

Also shown sandwiched between the bumper 50a and the upper end of the support member 30 in FIGS. 1 and 2 is a hanger bracket 58. Another hanger bracket 58 is similarly sandwiched between the bumper 50c and the upper end of the support member 34 (see FIG. 1). The illustrated hanger brackets 58 are configured to be connected to a hanging device, such as a chain 62, that can support the frame 14 in a hanging position. Each bracket 58 includes one or more apertures 66 for receiving the chain 62. Referring again to FIG. 2, the bracket 58 also includes an aperture 70 sized to receive the first leg 54a of the insert 54 so that the bracket 58 can be sandwiched between the bumper 50a and the upper end of the support member 30. Adhesive 56 can also be applied between the bracket 58 and the bumper 50a and/or between the bracket 58 and the support member 30. Alternatively, fasteners such as staples 55a and screws 55b can be used to help secure the bracket 58 to the support member 30. In the illustrated embodiment, the brackets 58 are made of metal, however, plastics can also be used.

As best seen in FIG. 1, the window bumper 50c can be connected to the upper end of the member 34 using an insert 54 in the same manner described above with respect to FIG. 2. The window bumper 50d can be connected to the lower end of the member 34 in a similar manner using an insert 54. As seen in FIG. 1, the abutting ends of the bumper 50d and the member 34 are preferably cut at forty-five degree angles to form a mitered joint J. Adhesive can be applied along the mitered joint J if desired. The window bumpers 50e-50h are similarly connected on the respective ends of the horizontal members 38 and 46.

FIG. 3 illustrates a slightly modified insert 54′. The insert 54′ includes a rounded transition or corner portion 54c′ between the legs 54a′ and 54b′. The rounded corner portion 54c′ provides an aesthetically-pleasing, smooth transition between the interconnected support member and window bumper, thereby eliminating the additional cutting needed to create the mitered joints J shown in FIG. 1.

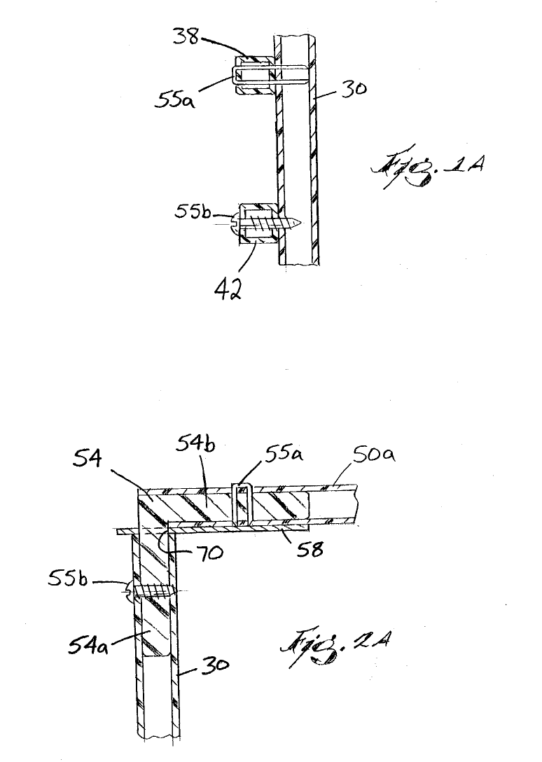

FIG. 4 illustrates another arrangement for interconnecting a window bumper. Specifically, FIG. 4 illustrates how the bumper 50b is connected to the lower end of the support member 30 in the event that a rearwardly-extending support foot 74 is added to the frame 14. Support feet 74 (one of which is shown in phantom in FIG. 1) can be added to the frame 14 to provide additional stability when the frame 14 is to stand on a horizontal surface (not shown), such as a window sill, table, desk, and the like.

When a support foot 74 and a window bumper 50 are both to be connected to a support member 30 or 34, a T-shaped insert 78 can be used to structurally support the three-way interconnection. The T-shaped insert 78 includes first and second legs 78a and 78b, respectively, that are received in the respective open end of the support member 30 and the open end of the bumper 50b in the same manner discussed above with respect to the L-shaped insert 54. The T-shaped insert 78 further includes a third leg 78c sized and configured to fit snugly within an open end of the support foot 74. As is the case with using the L-shaped insert 54, adhesive can be used between the third leg 78c and the support foot 74 to further secure the interconnection. In the event that the frame 14 will be used interchangeably between free-standing and hanging positions, it may be desirable to forego the use of mechanical fasteners or adhesives so that the support foot 74 can be added and removed as desired. When the support foot 74 is removed, the T-shaped insert 78 can be replaced with an L-shaped insert 54 to achieve the two-way interconnection seen between the lower end of the support member 34 and the window bumper 50d.

Both the L-shaped inserts 54, 54′ and the T-shaped inserts 78 are preferably made from plastic that is molded or cut to size. In the illustrated embodiment, the inserts 54, 54′, and 78 are made of laser-cut polycarbonate. The legs have rectangular, and more precisely substantially square cross-sections corresponding in shape and sized to fit snugly inside the cavity in each extruded support member 30, 34, 38, 42, 46, window bumper 50a-50h, and support foot 74. Alternatively, the inserts 54, 54′, and 77 can be made from other suitable plastic materials or metals.

The support members 30, 34, 38, 42, and 46 of the frame 14 support a plurality of tube hangers 82 positioned to support the tube 18 on the front side of the frame 14. The tube hangers 82 are plastic and each tube hanger 82 includes a base portion 86 and a clip portion 90 extending from the base portion 86. The base portion 86 is secured to one of the support members 30, 34, 38, 42, and 46 via a fastener 92, such as a screw, a rivet, a staple, or any other suitable device. Adhesive can also be used instead of, or in addition to the fastener 92. The fastener 92 extends through a flange 93 in the base portion 86 and into the respective support member 30, 34, 38, 42, and 46. Because the support members 30, 34, 38, 42, and 46 are plastic, insertion of the fastener 92 into the support members 30, 34, 38, 42, and 46 does not require pre-drilling or pre-punching of holes, as is commonly done on prior art metal frames. An alternative method of fastening the tube hangers 82 to the support members 30, 34, 38, 42, and 46 will be described below with respect to FIG. 9.

The clip portion 90 includes a post 94 and a C-shaped, resilient clip 98 at one end of the post 94. The clip 98 is configured to snap onto the tube 18 to support the tube 18 when the tube hanger 82 is mounted on a support member 30, 34, 38, 42, or 46. The post 94 is slidably received and retained inside the base portion 86, which is spring-loaded to allow for a predetermined amount of axial movement of the clip portion 90 with respect to the base portion 86.

As described thus far, the frame 14 is constructed almost entirely of plastic, with possible exceptions being the hanger brackets 58 and the fasteners 92, all of which could also be made of plastic instead of metal. Because the frame 14 is made largely or entirely of plastic, there is no need to electrically ground the frame 14, as is required with prior art metal frames.

The construction of the frame 14 from extruded plastic members provides additional flexibility not available in prior art metal frames. Specifically, the exterior shape of the extruded plastic members provides added flexibility for using hanger brackets of different configurations. For example, FIG. 5 illustrates a wire hanger bracket 102 that can be configured to wrap around two or more support members 30, 34, 38, 42, and 46 in a manner that eliminates the need for using fasteners to secure the bracket 102 to the frame 14. FIG. 6 illustrates another bracket 106 that is configured to wrap around only one member of the frame 14. The bracket 106 can be slidably installed over the end of any support member 30, 34, 38, 42, and 46, window bumper 50, or support foot 74.

The internal cavity formed in each extruded frame member also provides additional flexibility. For example, FIG. 7 illustrates how a reinforcing rod or member 110 can be inserted into the cavity in one or more plastic frame members to stiffen the frame 14. The reinforcing rod 110 can be used when the frame 14 is required to support a heavier tube 18 and/or power supply 22, or is required to hold additional display items. While the reinforcing rod 110 is illustrated as having a substantially square cross-section, rods having circular or other cross-sections can be substituted. The reinforcing rod 110 can be made from the same polycarbonate as the inserts 54, 54′, and 78, or alternatively can be made from other plastics or metals.

As shown in FIG. 7, the reinforcing rod 110 can also provide a manner of forming a butt-joint between two frame members extending in line with one another. In this sense, the reinforcing rod 110 acts like an I-shaped insert to bridge a joint between two abutting frame members. Adhesive can be used as described above to further secure the joint. Of course, the reinforcing rod 110 can be cut to any desired length depending on need.

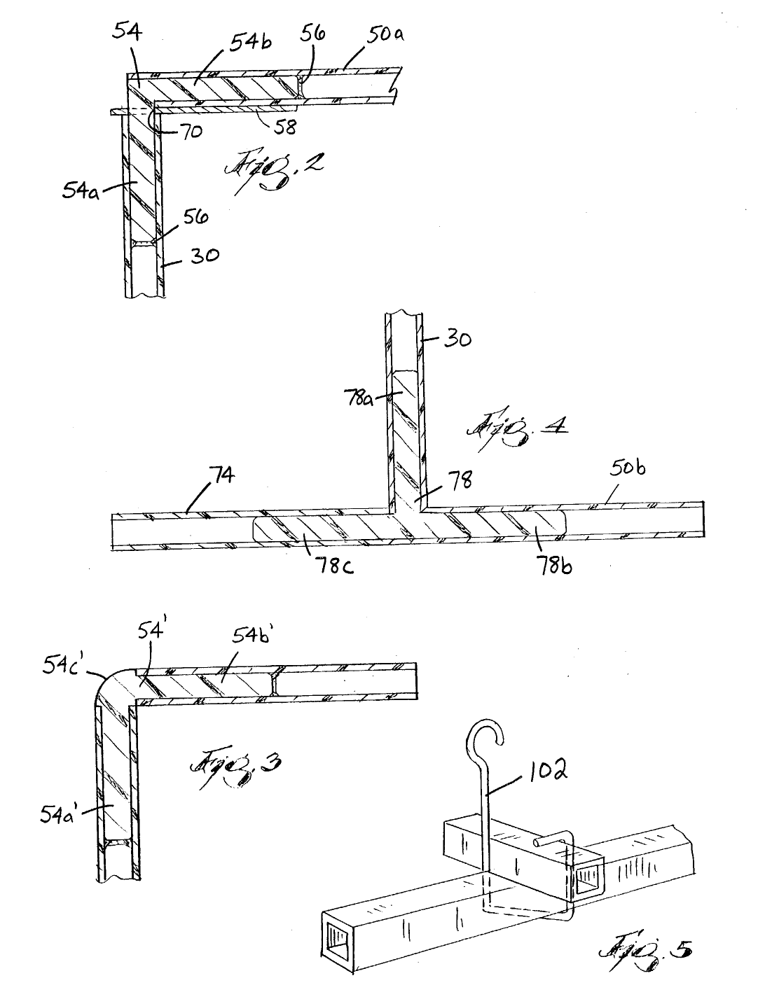

FIG. 8 illustrates a frame member acting as a conduit for electrical wires 114. Where the size of the internal cavity in the frame members is sufficient, the wires 114 can be run inside the frame members to hide and protect the wires 114 from the environment.

As mentioned above, the frame members need not be limited to the cross-sectional configuration shown in FIGS. 1-8. Because the plastic extrusion process is so flexible, virtually any cross-sectional configuration can be used for the frame members. For example, FIGS. 9 and 10 illustrate how the cross-sectional shape of the interior cavity can be changed. Specifically, FIG. 9 illustrates a frame member having a substantially circularly-shaped interior cavity 118, while FIG. 10 illustrates a frame member having a substantially hexagonally-shaped interior cavity 122.

FIG. 9 further illustrates an alternative manner for securing the tube hangers 82 to the frame 14. Specifically, the base portions 86 and the fasteners 92 could be replaced with alternative base portions 86′ that include a resilient clip 126 configured to snap and/or slide onto and along the exterior surface of the frame members as shown. Using the clips 126 to replace the fasteners 92 can further facilitate assembly of the frame 14. The clips 126 can be configured to be received on frame members having different exterior cross-sectional configurations as well.

Once again, because the plastic extrusion process is so flexible, virtually any cross-sectional configuration can be used for the frame members. Both the exterior cross-sectional shape and the shape of the interior cavity or cavities can be varied for added strength, rigidity, connectability, and the like. For example, FIG. 11 illustrates a portion of a frame member 130 having a rectangularly-shaped tubular cross-section with a rectangularly-shaped interior cavity.

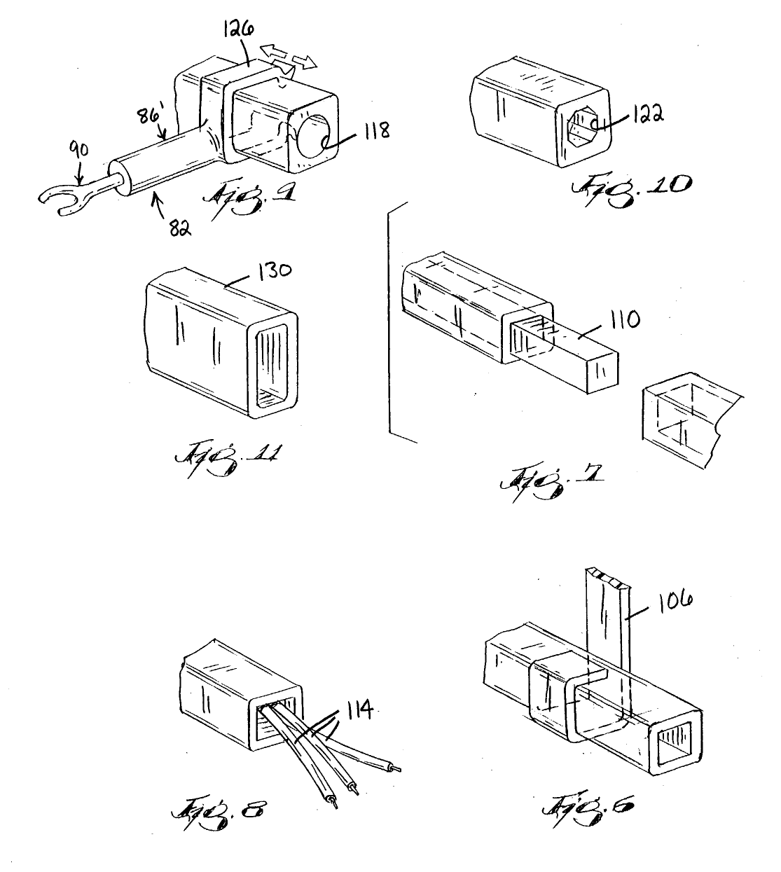

FIG. 12 illustrates a portion of a frame member 132 having a configuration defining a longitudinally-extending groove or recess 134 in the exterior surface and having three separate rectangularly-shaped interior cavities. The groove 134 can be useful for attaching hanger brackets and/or tube hangers, and can also be useful for routing electrical wiring.

FIG. 13 illustrates a portion of a frame member 136 similar to the frame member 130.

FIG. 14 illustrates a portion of a frame member 138 with an exterior surface defining a longitudinally-extending groove or recess 140 that is shaped in substantially an inverted T-configuration to define a track in which hanger brackets and/or tube hangers can be slidably positioned. Electrical wiring could also be routed in the groove 140.

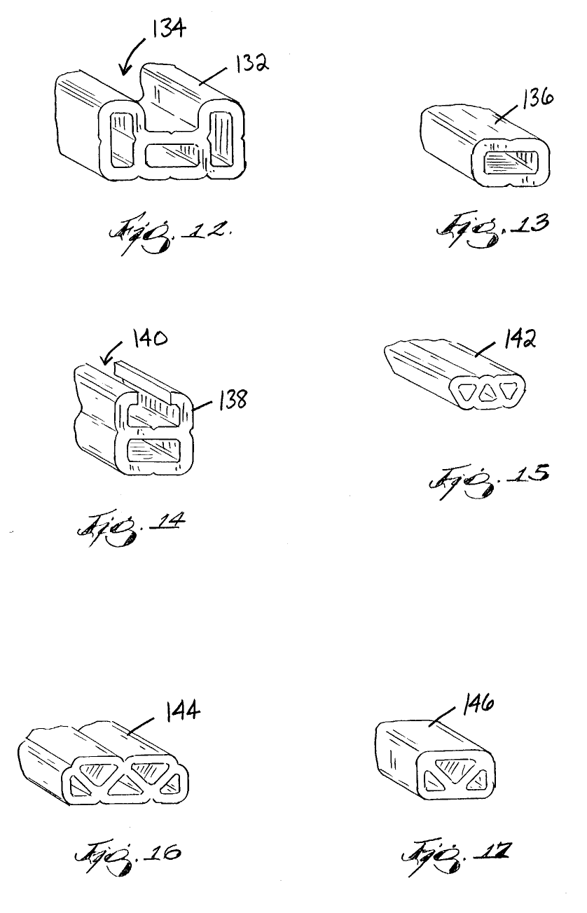

FIG. 15 illustrates a portion of a frame member 142 having three triangularly-shaped interior cavities.

FIG. 16 illustrates a portion of a frame member 144 having five triangularly-shaped interior cavities.

FIG. 17 illustrates a portion of a frame member 146 having a rectangularly-shaped cross section with three triangularly-shaped interior cavities.

FIG. 18 illustrates a portion of a frame member 148 having a longitudinally-extending rib 150 on one side and a longitudinally-extending groove or recess 152 on the side opposite the rib 150.

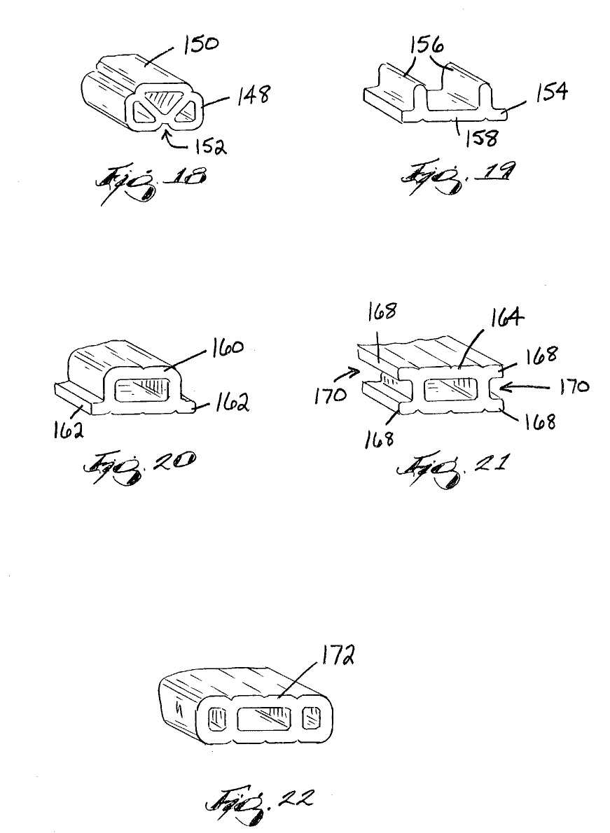

FIG. 19 illustrates a portion of a frame member 154 that includes two longitudinally-extending ribs 156 on a substantially planar base portion 158.

FIG. 20 illustrates a portion of a frame member 160 similar to the frame member 136 but with two longitudinally-extending ribs 162.

FIG. 21 illustrates a portion of a frame member 164 similar to the frame member 160 and including four longitudinally extending ribs 168. The ribs 168 define oppositely facing longitudinally-extending U-shaped grooves or recesses 170.

FIG. 22 illustrates a portion of a frame member 172 with a substantially rectangular cross-section having three separate rectangularly-shaped interior cavities.

The frame member configurations illustrated in FIGS. 1-22 are just a few of the possible frame member configurations that can be used. Those skilled in the art of plastic extrusion will understand that the number of possible configurations available for frame members is virtually limitless.

The ease with which the frame 14 can be configured and assembled without the use of metal bending equipment or other special tools makes the frame 14 well-suited for sale as a custom frame kit that can be assembled in any desired configuration by the party purchasing the kit. The kit can include one or more lengths of plastic extrusion that can be cut to size (using a miter saw or similar cutting device) to form the support members 30, 34, 38, 42, and 46, the window bumpers 50, and the feet 74. A plurality of inserts 54, 54′, and 78 and a container (not shown) of adhesive 56 or fasteners 55a, 55b can also be included in the kit. Alternatively, the adhesive or fasteners could be sold separately. Finally, the kit could also include tube hangers 82 with fasteners 92 or tube hangers 82 with clips 126, hanger brackets 58, 102, 106, and possibly one or more lengths of chain 62. If desired, the kit could further include one or more support rods 110.

1. A frame for supporting a sign having a gas discharge tube, the frame comprising:
a plurality of frame members, each of the frame members being made entirely of extruded plastic; and
a plurality of tube hangers coupled to the frame members for supporting the tube.

2. The frame of claim 1, wherein at least some of the frame members are made of at least one of extruded polycarbonate and extruded polyvinyl chloride.

3. The frame of claim 1, wherein at least some of the frame members are fastened together by at least one of staples, screws, adhesives, heat welding, friction welding, and solvent bonding.

4. The frame of claim 1, wherein the tube hangers are coupled to the frame members via at least one of screws, rivets, and clips.

5. The frame of claim 1, wherein the frame members include at least one of a generally vertically-extending support member, a generally horizontally-extending support member, a window bumper, and a support foot.

6. The frame of claim 1, further including an insert that engages both a first and a second frame member.

7. The frame of claim 6, wherein the insert is plastic.

8. The frame of claim 6, wherein the insert is substantially L-shaped.

9. The frame of claim 8, wherein the L-shaped insert includes a rounded corner portion that creates a substantially smooth interface between the first and second frame members.

10. The frame of claim 6, wherein the insert engages the first frame member, the second frame member, and a third frame member, and wherein the insert is substantially T-shaped.

11. The frame of claim 1, further including a bracket coupled to at least one of the frame members for hanging the frame.

12. The frame of claim 1, further including a rod inside a first frame member that stiffens the first frame member.

13. A method of manufacturing a frame for a sign having a gas discharge tube, the method comprising:
extruding a length of plastic; and
forming the sign from the length of extruded plastic.

14. The method of claim 13, wherein the forming step includes:
cutting the length of plastic into a plurality of plastic members; and
securing the plurality of plastic members together to form the frame.

15. The method of claim 14, wherein the securing step includes:
securing at least some of the plastic members together by at least one of staples, screws, adhesives, heat welding, friction welding, and solvent bonding.

16. The method of claim 14, wherein the securing step includes:
securing at least some of the plastic members together using an insert received at least partially in an interior cavity defined in each of the plastic members being secured together.

17. The method of claim 14, wherein the cutting step includes:
cutting the length of plastic at substantially a 45 degree angle to facilitate forming a mitered joint between abutting plastic members.

18. The method of claim 13, wherein the extruding step includes:
extruding a length of plastic that is substantially rectangular in cross-section with a substantially rectangularly-shaped interior cavity.

19. The method of claim 13, wherein the extruding step includes:
extruding a length of plastic with an outer surface having at least one of a longitudinally-extending groove and a longitudinally-extending rib.

20. The method of claim 13, wherein the extruding step includes:
extruding a length of plastic having an interior cavity that is at least one of substantially square, substantially rectangular, substantially circular, substantially triangular, and substantially hexagonal in cross-section.

21. A frame for supporting a sign having a gas discharge tube, the frame comprising:
a first member made of extruded plastic and having an open end;
a second member made of extruded plastic and having an open end; and
an insert having a first leg received in the end of the first member and a second leg received in the end of the second member such that the first and second members are oriented substantially normal to one another.

22. The frame of claim 21, further comprising a bracket disposed between the first and second members, the first leg of the insert extending through an aperture in the bracket.

23. The frame of claim 21, wherein the end of the first member and the end of the second member are each cut at about a 45 degree angle.

24. The frame of claim 21, further including at least one of a mechanical fastener and an adhesive between one of the first and second members, the first member and the insert, and the second member and the insert to help secure the first and second members together.

25. The frame of claim 21, wherein the insert is substantially L-shaped.

26. The frame of claim 25, wherein the L-shaped insert includes a rounded corner portion between the first and second legs that creates a substantially smooth interface between the first and second members.

27. The frame of claim 21, wherein the insert is substantially T-shaped.

28. The frame of claim 27, further comprising a third member having an open end, and wherein the T-shaped insert includes a third leg received in the open end of the third member.

29. The frame of claim 21, further including a tube hanger coupled to one of the first and second members.

30. The frame of claim 29, wherein the tube hanger includes a clip configured to snap onto an outer surface of one of the first and second members.

31. The frame of claim 30, wherein the clip is slidable along the outer surface.

32. The frame of claim 21, wherein the insert is made of at least one of plastic and metal.

33. The frame of claim 21, further including a rod inside at least one of the first and second members.

34. The frame of claim 33, wherein the rod is made of at least one of plastic and metal.

35. The frame of claim 21, wherein the first member is substantially tubular.

36. The frame of claim 35, wherein the first member defines a cavity that is at least one of substantially rectangular, substantially circular, substantially triangular, and substantially hexagonal in cross-section.

37. The frame of claim 35, further including wires housed within the first tubular member.

38. The frame of claim 21, wherein the first member has an outer surface that is substantially rectangular in cross-section.

39. The frame of claim 21, wherein the first member has an outer surface with at least one of a longitudinally-extending groove and a longitudinally-extending rib.

40. The frame of claim 21, further including a bracket having a portion wrapped at least partially around an outer surface of the first member.

41. The frame of claim 40, wherein the bracket has a portion wrapped at least partially around the outer surface of the first member and an outer surface of the second member.

42. The frame of claim 21, wherein the first and second members are made of at least one of extruded polycarbonate and extruded polyvinyl chloride.
